(19) United States
(12) Patent Application Publication
(10) Pub. No.: US 2025/0386141 A1
(43) Pub. Date: Dec. 18, 2025

(54) RUBBER DIAPHRAGM AND SOUND-GENERATING DEVICE

(71) Applicant: AAC Microtech (Changzhou) Co., Ltd., Changzhou City (CN)

(72) Inventors: Jiong Xie, Changzhou (CN); Xiaoman Hou, Changzhou (CN); Zhongwei Wang, Changzhou (CN); Ronglin Linghu, Changzhou (CN); Hongyuan Wang, Changzhou (CN)

(21) Appl. No.: 18/979,489

(22) Filed: Dec. 12, 2024

Related U.S. Application Data
(63) Continuation of application No. PCT/CN2024/098956, filed on Jun. 13, 2024.

(51) Int. Cl. H04R 7/10; C08F 110/02; C08K 5/09; C08K 5/10

(52) U.S. Cl. CPC H04R 7/10; C08F 110/02; C08K 5/09; C08K 5/10; C08F 2810/20; H04R 2307/025

(57) ABSTRACT

The present application provides a rubber diaphragm and a sound-generating device. The diaphragm is prepared from a polymer matrix and an additive by a vulcanization crosslinking reaction. The additive includes fillers, vulcanizing agents, accelerators, plasticizers, and activators; in terms of parts by weight, addition amounts of the polymer matrix and the additives are, 100 parts of polymer matrix, 40-120 parts of fillers, 1-4 parts of vulcanizing agents, 2-5 parts of accelerators, 5-20 parts of plasticizers, and 0.5-1.5 parts of activators, respectively. The diaphragm is prepared by the selection of the type of polymer matrix and the additive as well as the co-compatibility between the addition amounts of raw materials. Various performance indexes of the diaphragm are stable under low-temperature environments, which ensures that the sound-generating device made with the diaphragm has stable performance in low-temperature environments.

### CROSS-REFERENCE TO RELATED APPLICATIONS

This application is a continuation of International Application No. PCT/CN2024/098956, Jun. 13, 2024, the entire contents of which is incorporated herein by reference.

### TECHNICAL FIELD

The present application relates to the field of electroacoustic conversion technologies, in particular to a rubber diaphragm and a sound-generating device.

### BACKGROUND

Rubber diaphragm materials in the related art are generally prepared from thermoplastic elastomers including thermoplastic polyester elastomer (TPEE), thermoplastic polyurethane elastomer rubber (TPU), or thermosetting elastomers such as nitrile rubber and acrylate rubber as raw materials. The rubber diaphragm obtained in the related art has poor low-temperature resistance. In low-temperature environments (such as outdoor temperatures in northern regions can reach below −25° C.), the modulus of elasticity of the diaphragm rises dramatically, resulting in a reduction in the Cms (Cms is the force compliance, which refers to the mechanical compliance of the supporting parts of the speaker vibration system) of the vibration system of the acoustic device, an increase in the F0 (F0 is the lowest resonance frequency, which refers to the frequency corresponding to the first great value of the impedance curve of the loudspeaker), a drastic decrease in the sensitivity, and a decrease in the stability of the product, and a great limitation of the application environment.

Therefore, it is necessary to provide a rubber diaphragm and sound-generating device with better low-temperature resistance.

### SUMMARY

The purpose of the present application is to solve the above problem and provide a rubber diaphragm and a sound-generating device.

The technical solution of the present application is as follows.

In a first aspect, the present application provides a rubber diaphragm, prepared from a polymer matrix and an additive by a vulcanization crosslinking reaction;
wherein the polymer matrix is ethylene acrylate rubber with the structural formula:

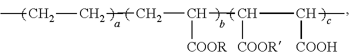

wherein R and R′ independently represent one of methyl, ethyl, or n-butyl, respectively; and a, b, and c are positive integers;
the additive comprises fillers, vulcanizing agents, accelerators, plasticizers, and activators; in terms of parts by weight, addition amounts of the polymer matrix and the additives are, 100 parts of polymer matrix, 40-120 parts of fillers, 1-4 parts of vulcanizing agents, 2-5 parts of accelerators, 5-20 parts of plasticizers, and 0.5-1.5 parts of activators, respectively.

In an embodiment, a proportion of ethylene chain segments and acrylate chain segments in the polymer matrix is between 1-8, and a proportion of n-butyl in the side groups R and/or R′ is 10-30%.

In an embodiment, the plasticizer comprises one or more of a benzene dicarboxylic acid plasticizer, an aliphatic dibasic acid ester plasticizer, a polyester plasticizer, or an ether ester plasticizer.

In an embodiment, the vulcanizing agent comprises one or more of a peroxide vulcanizing agent, an isocyanate vulcanizing agent, an epoxy vulcanizing agent, an amine vulcanizing agent, or an aziridine vulcanizing agent.

In an embodiment, the accelerator comprises one or more of an amine accelerator, a thiazole accelerator, a thiuram accelerator, a diphenylguanidine accelerator, a dithiocarbamate accelerator, and a thiourea accelerator.

In an embodiment, the activator comprises one or more of stearic acid, or fatty acids and derivatives of the fatty acids.

In an embodiment, on the basis of 100 parts by weight of the polymer matrix, the additives further comprise 0.5-3 parts of a coupling agent, 1-3 parts of an antioxidant, and 1-5 parts of a release agent.

In a second aspect, the present application provides a sound-generating device comprising a base frame, a vibration system and a magnetic circuit system accommodated within the base frame, a middle diaphragm, an upper diaphragm, and a lower diaphragm; wherein at least one of the middle diaphragm, the upper diaphragm, and the lower diaphragm is prepared using the rubber diaphragm as described above.

The beneficial effect of the present application is: in the rubber diaphragm of the present application, the diaphragm is prepared from the polymer matrix and the additive by a vulcanization and cross-linking reaction. The polymer matrix is a low-temperature class of ethylene acrylate rubber, the additive includes fillers, vulcanizing agents, accelerators, plasticizers, and activators. In the present application, the diaphragm is prepared by co-combination between the type of polymer matrix and the choice of additives, as well as the amount of raw materials added. The glass transition temperature Tg (DMA, 1 Hz, 3 K/min) of the obtained diaphragm is between −20 and −40° C., and the multiplicity of the modulus change in high and low temperature is less than 4.5 at the low temperature of −20° C. and the room temperature of 25° C. Compared with the diaphragm materials in the related art, the diaphragm materials of the present application are stable under low-temperature environments in various performance indexes, which ensures that the sound-generating device made with the diaphragm of the present application has stable performance in a low-temperature environment.

### BRIEF DESCRIPTION OF THE DRAWINGS

FIG. 1 shows a graph of dynamic thermo-mechanical analysis curves before and after high-temperature reliability tests for a diaphragm using a conventional plasticizer.

FIG. 2 shows a graph of dynamic thermo-mechanical analysis curves before and after high-temperature reliability tests for a diaphragm using the plasticizer of the present application.

FIG. 3 shows a graph of dynamic thermo-mechanical analysis test curves of the diaphragm of the present application and the diaphragm in the Comparison embodiment one.

FIG. 4 shows frequency response graphs of the diaphragm of the present application and the diaphragm of the Comparison embodiment one after being applied to the sound-generating device.

FIG. 5 shows a structural schematic diagram of the sound-generating device according to an embodiment of the present application.

FIG. 6 shows an exploded view of the sound-generating device of the embodiment according to the present application.

### DETAILED DESCRIPTION OF THE EMBODIMENTS

The present application is further described below in connection with the accompanying drawings and embodiments.

Embodiment one: in the first aspect, an embodiment of the present application provides a rubber diaphragm, which is prepared from a polymer matrix and an additive by a vulcanization crosslinking reaction.

The polymer matrix is an ethylene acrylate rubber with the structural formula:

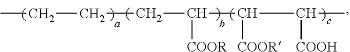

in which R and R′ independently represent one of methyl, ethyl or n-butyl, respectively, and a, b, and c are positive integers.

The additive includes fillers, vulcanizing agents, accelerators, plasticizers, and activators. In terms of parts by weight, the additive amounts of the polymer matrix and the additives are as follows: 100 parts of polymer matrix, 40-120 parts of fillers, 1-4 parts of vulcanizing agents, 2-5 parts of accelerators, 5-20 parts of plasticizers, and 0.5-1.5 parts of activators, respectively.

In an embodiment, the rubber diaphragm obtained from the present application can be applied to a micro sound-generating device.

In the rubber diaphragm described in the present application, the diaphragm is prepared from the polymer matrix and the additive by a vulcanization and cross-linking reaction. The polymer matrix is a low-temperature class of ethylene acrylate rubber, the additive includes fillers, vulcanizing agents, accelerators, plasticizers, and activators. In the present application, the diaphragm is prepared by co-combination between the type of polymer matrix and the choice of additives, as well as the amount of raw materials added. The glass transition temperature Tg (DMA, 1 Hz, 3 K/min) of the obtained diaphragm is between −20 and −40° C., and the multiplicity of modulus change in high and low temperature is less than 4.5 at the low temperature of −20° C. and the room temperature of 25° C. Compared with the diaphragm materials in the related art, the diaphragm materials of the present application are stable under low-temperature environments in various performance indexes, which ensures that the sound-generating device made with the diaphragm of the present application has stable performance in a low-temperature environment.

In an embodiment, a proportion of ethylene chain segments and acrylate chain segments in the polymer matrix is between 1-8, and a proportion of n-butyl groups in side groups R and/or R′ is 10-30%.

For the ethylene acrylate rubber, firstly, the ethylene chain segment as a soft segment, the size of its proportion in the molecular chain is a key factor directly affecting the low-temperature characteristics of the rubber, the higher the proportion of the ethylene chain segment is, the better the low-temperature characteristics are. Secondly, the length of the side group of the acrylate will also affect the low-temperature characteristics of the rubber to a certain extent. The longer the side group is, the better the molecular chain is supple, and the better the low-temperature characteristics are. Therefore, in the present application, the low-temperature resistance properties as well as the hardness requirements are comprehensively considered, so that the ratio of ethylene chain segments and acrylate chain segments in the obtained polymer matrix is in the range of 1-8, and the proportion of n-butyl groups in the side groups R and/or R′ is in the range of 10-30%.

In an embodiment, the plasticizer comprises one or more of a benzene dicarboxylic acid plasticizer, an aliphatic dibasic acid ester plasticizer, a polyester plasticizer or an ether ester plasticizer.

In an embodiment, the plasticizer is a hybrid ether ester plasticizer. The hybrid ether ester plasticizer may be sourced from a supplier known in the art or prepared by a well-known method.

The hybrid ether ester plasticizer selected in the present application is a small molecule compound that is polar or partially polar in structure. It can be uniformly distributed between the polymer macromolecular chains, so as to reduce the intermolecular force, make the polymer material viscosity lower, and enhance the flexibility of the molecular chain, resulting in a lower material glass transition temperature and improving low-temperature characteristics. The mixed ether ester plasticizers selected in the present application are used as a single variable to prepare the diaphragm, and the glass transition temperature of the obtained diaphragm as well as E′(−20° C.)/E′(25° C.) are determined. E′(−20° C.) represents the energy storage modulus of the diaphragm in a low-temperature environment of −20° C., and E′(25° C.) represents the energy storage modulus of the diaphragm in a room temperature of 25° C., where the ratio of both values can indirectly reflect the diaphragm in the low temperature and room temperature changes in the size of the situation. The smaller the ratio is, the better the low-temperature resistance characteristics are. Table 1 shows the corresponding relationship between the amount of plasticizer added to the diaphragm of the present application and the diaphragm transition temperature as well as E′(−20° C.)/E′(25° C.). The glass transition temperature Tg (DMA, 1 Hz, 3K/min) of the obtained diaphragm is between−20 and −40° C., and the multiplicity of the modulus change between high and low temperatures is less than 4.5 at the low temperature of −20° C. and the room temperature of 25° C.

TABLE 1

| Number of parts of plasticizer | 0 | 5 | 10 | 20 |
|---|---|---|---|---|
| Tg (° C.) | −25.8 | −27.9 | −31.4 | −36.2 |
| E′(−20° C.)/E′(25° C.) | 4.4 | 4.1 | 3.8 | 2.9 |

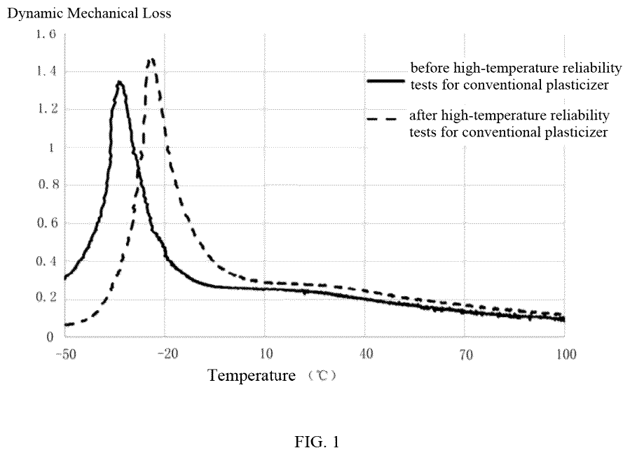

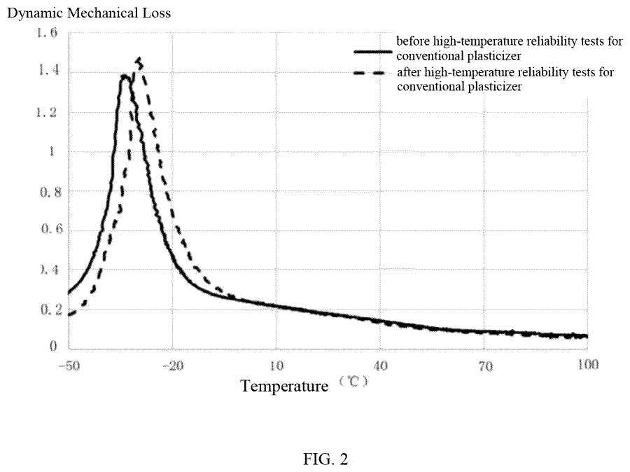

In the actual use of the process, the sound-generating device in a long period of time or access to the relevant high-temperature experiments, the diaphragm area temperature can reach 130° C., and part of the product instantaneous temperature may reach 150° C. Therefore, the high-temperature resistance of the diaphragm is also very important to the stability of the sound-generating device. High-temperature reliability tests are conducted on the diaphragms made with conventional plasticizers in the related art and the diaphragms made with the hybrid ether ester plasticizers of the present application. FIG. 1 shows a graph of DMA damping curves before and after the high-temperature reliability test for the diaphragm made with the conventional plasticizer in the related art (the temperature corresponding to the peak value is the glass transition temperature), and FIG. 2 shows a graph of dynamic mechanical analysis (DMA) damping curves before and after the high-temperature reliability test for the diaphragm made with the hybrid ether ester plasticizer of the present application (the temperature corresponding to the peak value is the glass transition temperature). As shown in FIGS. 1 and 2, the fluctuation of the glass transition temperature before and after the high-temperature reliability test for the diaphragm produced by the hybrid ether ester plasticizer of the present application is relatively small. The reason for this is that: when the sound-generating device made by the diaphragm in the related art with conventional plasticizer is in a long time working or high-temperature environment, the plasticizer in the diaphragm will evaporate and lead to serious damage to the low-temperature characteristics of the diaphragm, and also lead to increase in the hardness of the diaphragm, increase in the FO of the sound-generating device, decrease in sound pressure level (SPL), and decrease in the stability of the product. On the contrary, the diaphragm obtained by the present application is not only good at low temperatures, but also at high temperatures, up to 180° C. When applied to the diaphragm of the sound-generating device, it is not easy to evaporate, and the glass transition temperature of the diaphragm before and after the high-temperature experiment changes only 3° C., corresponding to the performance of the sound-generating device, such as FO, SPL, etc., there is no obvious change, and the product has good stability.

In an embodiment, the filler includes one or more of black carbon, silica, talc, quartz powder, hydrotalcite, calcium carbonate, siliceous loam, diatomite, nanoclay, or montmorillonite.

Taking the talcum powder filler as an example, the glass transition temperature and E′(−20° C.)/E′(25° C.) of the obtained diaphragm are determined by the addition amount of the filler described in the present application. E′(−20° C.) represents the energy storage modulus of the diaphragm in a low-temperature environment of −20° C., E′(25° C.) represents the energy storage modulus of the diaphragm in a room-temperature environment of 25° C., and the ratio of the two can reflect the changing size of the diaphragm in the low and room temperature indirectly. The smaller the ratio is, the better the low-temperature resistance is. Table 2 shows the correspondence between the content and Tg and E′(−20° C.)/E′(25° C.) of the diaphragm as described in the present application. As shown in Table 2, when the number of parts of filler parts increases, the contact area between the rubber molecular chain and the filler increases, and the internal friction increases, which restricts the movement of the molecular chain to a greater extent. Thus, the suppleness and elasticity of the molecular chain deteriorates, the glass transition temperature increases, and the low-temperature characteristics decrease. Within the preferred addition amounts of the present application, the glass transition temperature Tg (DMA, 1 Hz, 3 K/min) of the obtained diaphragm is in the range of −20 to −40° C., and the multiplicity of change in high and low-temperature modulus is less than 4.5 at low temperature of −20° C. and room temperature of 25° C.

TABLE 2

| Number of parts of filler | 80 | 90 | 100 | 108 |
|---|---|---|---|---|
| Tg (° C.) | −36.0 | −35.3 | −33.8 | −29.7 |
| E′(−20° C.)/E′(25° C.) | 3.1 | 3.2 | 3.5 | 3.9 |

In an embodiment, the vulcanizing agent includes one or more of a peroxide vulcanizing agent, an isocyanate vulcanizing agent, an epoxy vulcanizing agent, an amine vulcanizing agent, or an aziridine vulcanizing agent.

In an embodiment, the accelerator includes one or more of an amine accelerator, a thiazole accelerator, a thiuram accelerator, a diphenylguanidine accelerator, a dithiocarbamate accelerator, and a thiourea accelerator.

In an embodiment, the activator includes one or more of stearic acid, or fatty acids and derivatives thereof.

In an embodiment, on the basis of 100 parts by weight of the polymer matrix, the additives further comprise 0.5-3 parts of a coupling agent, 1-3 parts of an antioxidant, and 1-5 parts of a release agent.

In an embodiment, the coupling agent includes one or more of a silane-based coupling agent of model number KH550, KH-560, or KH-570 or a phthalate-based coupling agent of model number NDZ-101, NDZ-201, NDZ-311.

In an embodiment, the antioxidant includes one or more of antioxidant 264, antioxidant 2246, antioxidant MB, antioxidant MBZ, antioxidant SP or antioxidant 445.

In an embodiment, the release agent includes one or more of polyethylene wax, paraffin wax, ethylene bis stearate amide, oleic acid amide, erucic acid amide, phosphoric acid ester, or polymeric fatty acid ester.

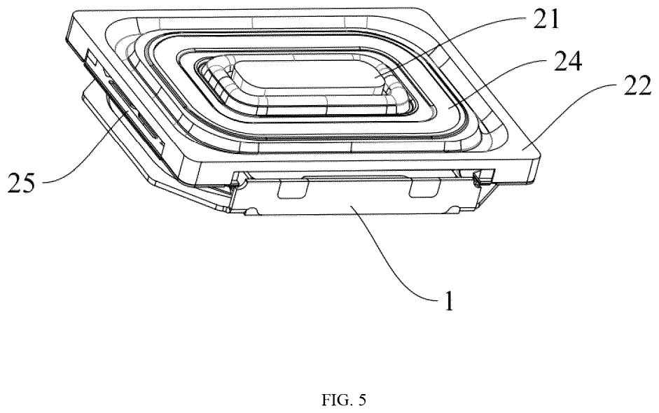

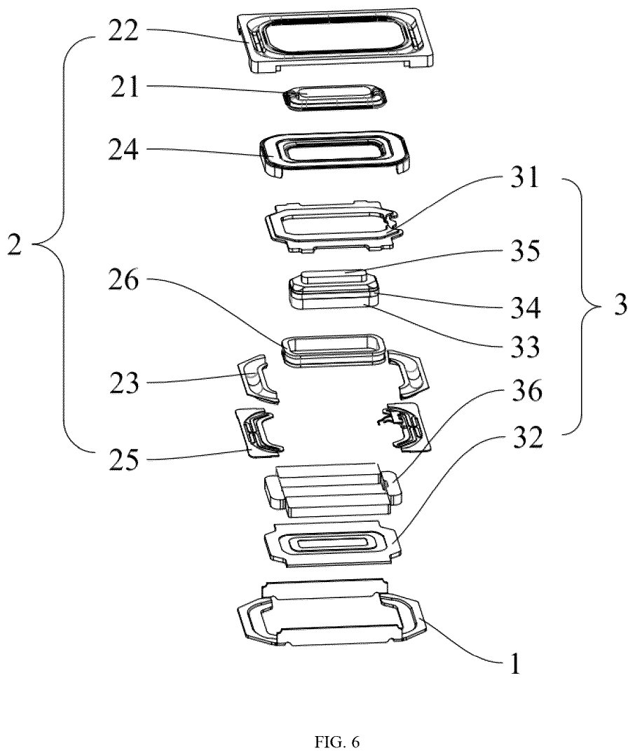

In a second aspect, the present application provides a sound-generating device. As shown in FIGS. 5 and 6, the sound-generating device includes a base frame 1, and a vibration system 2 and a magnetic circuit system 3 accommodated within the base frame 1. The vibration system 2 includes a middle diaphragm 21, an upper diaphragm 22, and a lower diaphragm 23. At least one of the middle diaphragm 21, the upper diaphragm 22, and the lower diaphragm 23 is prepared and obtained using the rubber diaphragm as described above.

In an embodiment, the sound-generating device is a micro sound-generating device.

The magnetic circuit system 3 includes an upper clamping plate 31 and a lower clamping plate 32 provided in parallel, an inner magnetic steel 33, a pole core 34 and an outer magnetic steel 35 provided on the lower clamping plate 32, and a side magnetic steel 36 provided in a circumferential direction along the inner magnetic steel 33. There is a magnetic gap between the inner magnetic steel 33 and the side magnetic steel 36, and the inner magnetic steel 33, the pole core 34, and the outer magnetic steel 35 are provided on the lower clamping plate 32 from bottom to top.

The vibration system 2 further includes a former 24, a flexible circuit board 25, and a voice coil 26. The middle diaphragm 21 is provided above the outer magnetic steel 35, and the former 24 is disposed at the periphery of the middle diaphragm 21. The upper diaphragm 22 is disposed at the periphery of the former 24, and the voice coil 26 is disposed within the magnetic gap. The lower diaphragm 23 is disposed below the upper diaphragm 22, and the flexible circuit board 25 is provided below the lower diaphragm 23 and in conduction with the voice coil 26. The former 24 is connected to the flexible circuit board 25 to support the vibration system 2 on the flexible circuit board 25.

Embodiment two: in this embodiment of the present application, the formulation for preparing the diaphragm includes 100 parts of low-temperature ethylene acrylate rubber (hereinafter referred to as low-temperature AEM raw rubber), 80 parts of filler, 2 parts of vulcanizing agent, 3 parts of accelerator, 1 part of activator, and 5 parts of mixed ether ester plasticizer. The filler is talc, the vulcanizing agent is hexylenediamine, the accelerator is tertiary amine, and the activator is stearic acid.

Embodiment three: in this embodiment of the present application, the formulation for preparing the vibratory film includes 100 parts of low-temperature AEM raw rubber, 100parts of filler, 2 parts of vulcanizing agent, 3 parts of accelerator, 1 part of activator, and 10 parts of hybrid ether ester plasticizer. The filler is talc, the vulcanizing agent is hexamethylenediamine, the accelerator is tertiary amine, and the activator is stearic acid.

Comparison embodiment one: the formulation for preparing the vibranium film in the Comparison embodiment includes 100 parts of conventional AEM raw rubber, 40 parts of filler, 2 parts of vulcanizing agent, 3 parts of accelerator, and 1 part of activator. The filler is talc, the vulcanizing agent is hexamethylenediamine, the accelerator is tertiary amine, and the activator is stearic acid.

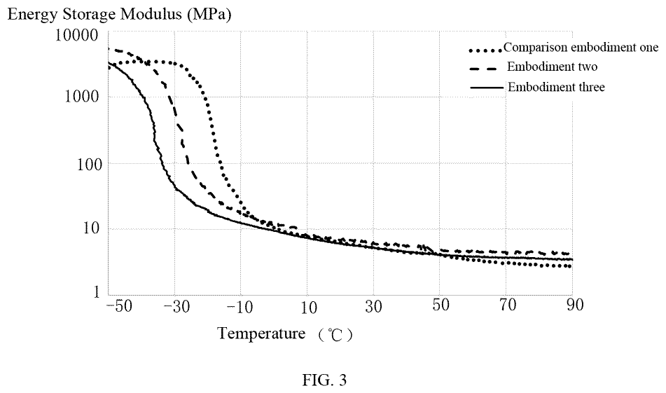

Test Example: Dynamic thermo-mechanical analysis tests were performed on the diaphragms made in Embodiment two, Embodiment three and Comparison embodiment one, respectively. FIG. 3 shows a graph of dynamic thermo-mechanical analysis test curves of the diaphragm of the present application and the diaphragm in the Comparison embodiment one. As shown in FIG. 3, compared to Comparison embodiment one, in the dynamic thermo-mechanical analysis (DMA) for the diaphragms made in Embodiment two and Embodiment three, the ratio of the energy storage modulus E′(−20° C.)/E′(25° C.) of the diaphragm obtained by the present invention in a low-temperature environment at −20° C. to the energy storage modulus in a room-temperature environment at 25° C. is smaller than E′(−20° C.)/E′(25° C.) of the diaphragm in the related art, which indicates that the diaphragm of the present application has a better low-temperature resistance characteristics.

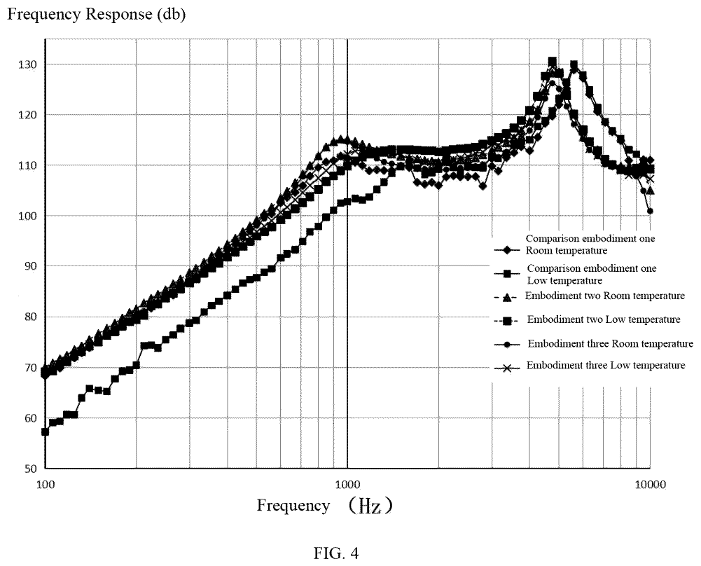

The diaphragms produced in Embodiment two, Embodiment three, and Comparison embodiment one were applied to the sound-generating device, and frequency response tests were performed on the sound-generating device, respectively. FIG. 4 shows frequency response graphs of the diaphragm of the present application and the diaphragm of the Comparison embodiment one after being applied to the sound-generating device. As shown in FIG. 4, compared to the Comparison embodiment one, the frequency response value of the diaphragm of the present application after being applied to the sound-generating device changed less under the condition of room temperature and low temperature, which indicates that the diaphragm of the present application has good low-temperature resistance characteristics, and that it has good low-temperature resistance characteristics.

In addition, the Sound Pressure Level (SPL) of the diaphragm of the present application at a low temperature of −20° C. changes less than 2 dB from room temperature after being applied to the sound-generating device.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A rubber diaphragm, prepared from a polymer matrix and an additive by a vulcanization crosslinking reaction;
wherein the polymer matrix is ethylene acrylate rubber with the structural formula: 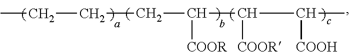
wherein R and R′independently represent one of methyl, ethyl, or n-butyl, respectively; and a, b, and c are positive integers;
the additive comprises fillers, vulcanizing agents, accelerators, plasticizers, and activators; in terms of parts by weight, addition amounts of the polymer matrix and the additives are, 100 parts of polymer matrix, 40-120 parts of fillers, 1-4 parts of vulcanizing agents, 2-5 parts of accelerators, 5-20 parts of plasticizers, and 0.5-1.5 parts of activators, respectively.

2. The rubber diaphragm of claim 1, wherein a proportion of ethylene chain segments and acrylate chain segments in the polymer matrix is between 1-8, and a proportion of n-butyl in the side groups R and/or R′ is 10-30%.

3. The rubber diaphragm of claim 1, wherein the plasticizer comprises one or more of a benzene dicarboxylic acid plasticizer, an aliphatic dibasic acid ester plasticizer, a polyester plasticizer or an ether ester plasticizer.

4. The rubber diaphragm of claim 1, wherein the plasticizer is a hybrid ether ester plasticizer.

5. The rubber diaphragm of claim 1, wherein the filler comprises one or more of black carbon, silica, talc, quartz powder, hydrotalcite, calcium carbonate, siliceous loam, diatomite, nanoclay or montmorillonite.

6. The rubber diaphragm of claim 1, wherein the vulcanizing agent comprises one or more of a peroxide vulcanizing agent, an isocyanate vulcanizing agent, an epoxy vulcanizing agent, an amine vulcanizing agent, or an aziridine vulcanizing agent.

7. The rubber diaphragm of claim 1, wherein the accelerator comprises one or more of an amine accelerator, a thiazole accelerator, a thiuram accelerator, a diphenylguanidine accelerator, a dithiocarbamate accelerator, and a thiourea accelerator.

8. The rubber diaphragm of claim 1, wherein the activator comprises one or more of stearic acid, or fatty acids and derivatives of the fatty acids.

9. The rubber diaphragm of claim 1, wherein on the basis of 100 parts by weight of the polymer matrix, the additives further comprise 0.5-3 parts of a coupling agent, 1-3 parts of an antioxidant, and 1-5 parts of a release agent.

10. A sound-generating device, comprising:
a base frame;
a vibration system accommodated within the base frame;
a magnetic circuit system accommodated within the base frame;
a middle diaphragm;
an upper diaphragm; and
a lower diaphragm;
wherein at least one of the middle diaphragm, the upper diaphragm, and the lower diaphragm is obtained by using the rubber diaphragm of claim 1.
